(19) United States
(12) Patent Application Publication
(10) Pub. No.: US 2007/0294374 A1
(43) Pub. Date: Dec. 20, 2007

(54) Music reproducing method and music reproducing apparatus

(75) Inventor: Hirofumi Tamori, Tokyo (JP)

Correspondence Address: WOLF GREENFIELD & SACKS, P.C., 600 ATLANTIC AVENUE, BOSTON, MA, 02210-2206, US

(73) Assignee: Sony Corporation, Tokyo (JP)

(21) Appl. No.: 11/820,144

(22) Filed: Jun. 18, 2007

(30) Foreign Application Priority Data
Jun. 20, 2006 (JP) JP2006-169644

(51) Int. Cl. G06F 15/16

(52) U.S. Cl. 709/219

(57) ABSTRACT

A music reproducing method in a music reproducing apparatus includes the steps of obtaining time-series meta information including a plurality of pieces of partial meta information corresponding to a plurality of parts of song data, each piece of the partial meta information including partial reproduced position information indicating a reproduced position in the song data and comment information indicating a comment about the song at the reproduced position; and displaying the comment indicated by each piece of the comment information on a display by referring to the time-series meta information during reproducing of the song data.

### CROSS REFERENCES TO RELATED APPLICATIONS

The present invention contains subject matter related to Japanese Patent Application JP 2006-169644 filed in the Japanese Patent Office on Jun. 20, 2006, the entire contents of which are incorporated herein by reference.

### BACKGROUND OF THE INVENTION

1. Field of the Invention

The present invention relates to a music reproducing method and a music reproducing apparatus.

2. Description of the Related Art

In an online shop or the like, songs are recommended to customers who listen to and purchase a song through introduction of reviews, for example, “the highlight (of this song) is good”, “the introduction (of this song) has dynamic guitar playing”, and “the last part (of this song) is particularly recommended”.

Other than the above-described method, a method for recommending songs among users is disclosed in Patent Document 1 (Japanese Unexamined Patent Application Publication No. 2004-54023), for example. In this method, users hold lists of recommended songs in their mobile terminals and the lists are exchanged among the terminals. In the mobile terminal of one of the users, a list of collected songs including the lists of songs recommended by other users is generated, and a song is selected from the list based on the number of users recommending the song.

On the other hand, Patent Document 2 (Japanese Unexamined Patent Application Publication No. 2005-70472) discloses a method for obtaining and displaying lyrics or a score of a song for Karaoke, other than reviews and recommendation of songs. In this method, when a song is to be reproduced by using a CD (compact disc) that does not contain lyrics information, the lyrics information is received from a database server via the Internet on the basis of TOC (table of content) information in the CD, and the lyrics of the song are displayed in accordance with a reproducing status of the song. Also, Patent Document 3 (Japanese Unexamined Patent Application Publication No. 8-102902) discloses a method for reproducing background video signals from a first medium and reproducing music signals and information of lyrics and score from a second medium so as to display the lyrics and score that are superimposed on the background video image on a monitor.

### SUMMARY OF THE INVENTION

However, the reviews introduced in the online shop or the like are evaluations of an entire song and are abstract, such as “the highlight (of this song) is good”, and “the last part (of this song) is particularly recommended”, as described above. Those reviews are expressed by only words without a direct relationship with reproducing of the song. Thus, those reviews are not always sufficient information for a user to decide to purchase the song. Also, at test listening of an entire song by streaming reproducing that has recently been common or at reproducing of a song after purchase, evaluations of respective parts of the song are not presented to the user in synchronization with reproducing of the song.

In the method disclosed in Patent Document 1, songs can be recommended among users through exchange of lists of recommended songs. However, at test listening or reproducing of an entire song, reviews of respective parts of the song are not presented to the user in synchronization with reproducing of the song.

Accordingly, the present invention is directed to presenting reviews of respective parts of a song to a user in synchronization with reproducing of the song at test listening or reproducing of the entire song so that the user can aurally and visually realize the feature of the song, the similarity and difference between the song and another, and so on, over details of the song.

According to an embodiment of the present invention, there is provided a music reproducing method in a music reproducing apparatus. The music reproducing method includes the steps of obtaining time-series meta information including a plurality of pieces of partial meta information corresponding to a plurality of parts of song data, each piece of the partial meta information including partial reproduced position information indicating a reproduced position in the song data and comment information indicating a comment about the song at the reproduced position; and displaying the comment indicated by each piece of the comment information on a display by referring to the time-series meta information during reproducing of the song data.

In the above-described music reproducing method, in a case where the time-series meta information of the song includes three pieces of partial meta information, a comment “start of the singing is good” is displayed on the display by first comment information in a period when the part indicated by first partial reproduced position information is reproduced, a comment “highlight is similar to X” is displayed on the display by second comment information in a period when the part indicated by second partial reproduced position information is reproduced, and a comment “key suddenly changes at the ending” is displayed on the display by third comment information in a period when the part indicated by third partial reproduced position information is reproduced.

According to an embodiment of the present invention, reviews of respective parts of a song can be presented to a user in synchronization with reproducing of the song at test listening or reproducing of the entire song, so that the user can aurally and visually realize the feature of the song, the similarity and difference between the song and another, and so on, over details of the song.

### BRIEF DESCRIPTION OF THE DRAWINGS

FIG. 1 shows an example of a music reproducing system according to an embodiment of the present invention;

FIGS. 2A and 2B show an example of time-series meta information;

FIG. 3 shows an example of displaying a comment;

FIG. 4 shows an example of displaying comments;

FIG. 5 shows an example of displaying comments;

FIG. 6 shows part of an example of a process of reproducing a song and displaying a comment;

FIG. 7 shows part of the example of the process of reproducing a song and displaying a comment;

FIG. 8 shows an example of a method for specifying a part by a user; and

FIG. 9 shows an example of a method for inputting a comment by the user.

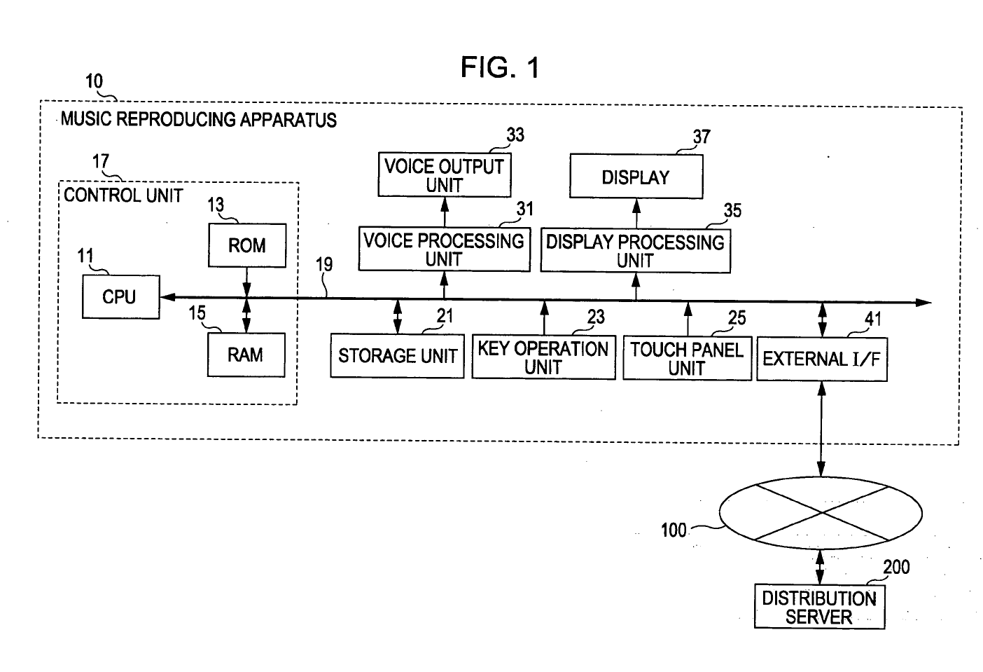

### DESCRIPTION OF THE PREFERRED EMBODIMENTS

<1. System Configuration: FIG. 1>

FIG. 1 shows an example of a music reproducing system including an example of a music reproducing apparatus 10 according to an embodiment of the present invention.

The music reproducing apparatus 10 includes a control unit 17 including a CPU (central processing unit) 11, a ROM (read only memory) 13, and a RAM (random access memory) 15, which connect to a bus 19. Various programs, including a program of reproducing a song and displaying a comment (described below), and data are written on the ROM 13. The programs and data are expanded in the RAM 15.

Also, a storage unit 21, a key operation unit 23, and a touch panel unit 25 connect to the bus 19. A voice output unit 33 connects to the bus 19 via a voice processing unit 31, and a display 37 connects to the bus 19 via a display processing unit 35.

The storage unit 21 is an internal storage device included in the music reproducing apparatus 10, such as a semiconductor memory or a hard disk, or an external storage device that is attached to or connected to the music reproducing apparatus 10 and that reads data from a storage medium, such as an optical disc or a memory card. Data including song data and time-series meta information is recorded on the storage medium.

The key operation unit 23 is used by a user to provide instructions to the music reproducing apparatus 10 or to input characters and so on. The touch panel unit 25 includes a touch panel provided on a screen of the display 37 and a position detecting unit.

The voice processing unit 31 processes voice data such as song data to reproduce the data. The voice output unit 33 is a voice amplifier and a speaker (headphone) connected thereto. The display processing unit 35 processes data of an image (screen) and a comment (text) to be displayed on the display 37. The display 37 is a liquid crystal display or an organic EL (electroluminescence) display.

Furthermore, an external interface 41 used to access a distribution server 200 via the Internet 100 connects to the bus 19.

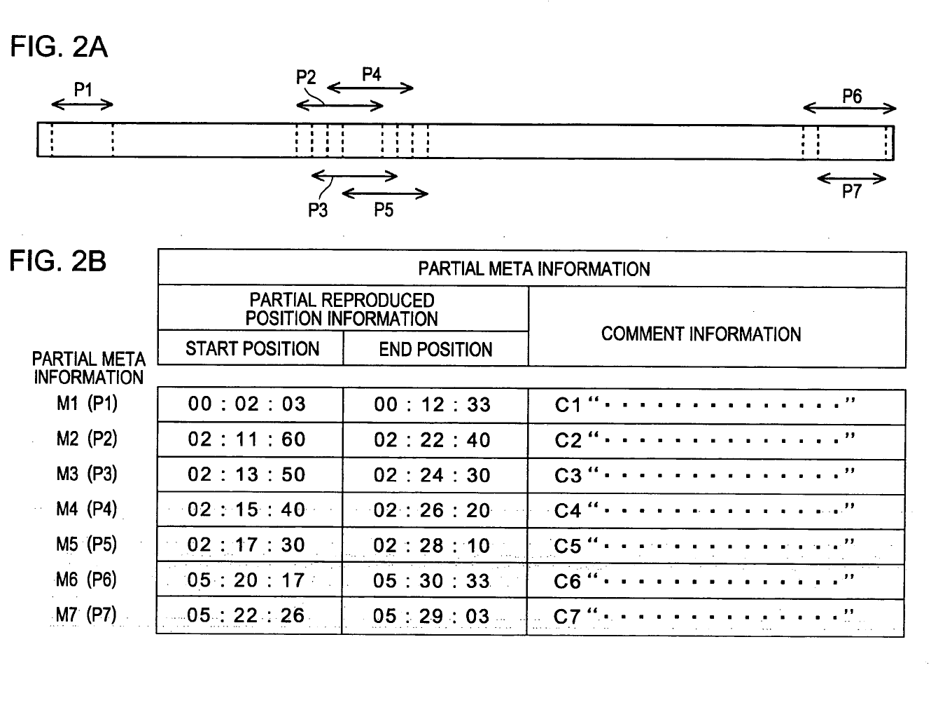

In this example, the distribution server 200 transmits song data and time-series meta information to the music reproducing apparatus 10. Also, the distribution server 200 serves as an information collector and receives user partial meta information that is generated by and transmitted from the music reproducing apparatus 10.

<2. Music Reproducing Method: FIGS. 2A and 2B to 9>

(2-1. Time-Series Meta Information: FIGS. 2A and 2B)

The time-series meta information in principle includes a plurality of pieces of partial meta information corresponding to different parts of a song. Each piece of partial meta information includes partial reproduced position information indicating a timing position (reproduced position) of a part in the song and comment information indicating a comment about the part.

In a song having a very short reproducing time length, the time-series meta information thereof may exceptionally include only a piece of partial meta information about one part. In most songs, however, the time-series meta information thereof includes a plurality of pieces of partial meta information corresponding to different parts of the song.

A plurality of comments and a plurality of pieces of comment information may be given to one part of the song.

Comments are made on respective parts of a song and pieces of partial meta information and entire time-series meta information are generated by a party who produces the song as song data or sells the song via distribution or a CD. The producer or seller of the song can make or add a comment by listening to users' opinions and comments.

FIGS. 2A and 2B show an example of the time-series meta information. In this example, song Sa has a reproducing time length of 5 minutes and 30.33 seconds as shown in FIG. 2A and has time-series meta information, which includes seven pieces of partial meta information M1, M2, . . . , and M7 as shown in FIG. 2B.

Each of the pieces of partial meta information M1, M2, . . . , and M7 includes partial reproduced position information and comment information. The partial reproduced position information indicates a start position (start time) and an end position (end time) of the corresponding part (period) in song Sa. The comment information indicates a comment about the corresponding part.

Specifically, in this example, comment C1 “start of the singing is good” is made on part P1 from 00:02:33 (0 minutes and 2.33 seconds) to 00:12:33 (0 minutes and 12.33 seconds) of song Sa. Also, comments C2, C3, C4, and C5 are made on partly overlapped four parts P2, P3, P4, and P5 having different start positions and end positions. Likewise, comment C6 is made on part P6 from 05:20:17 to 05:30:33, and comment C7 is made on part P7 from 05:22:26 to 05:29:03.

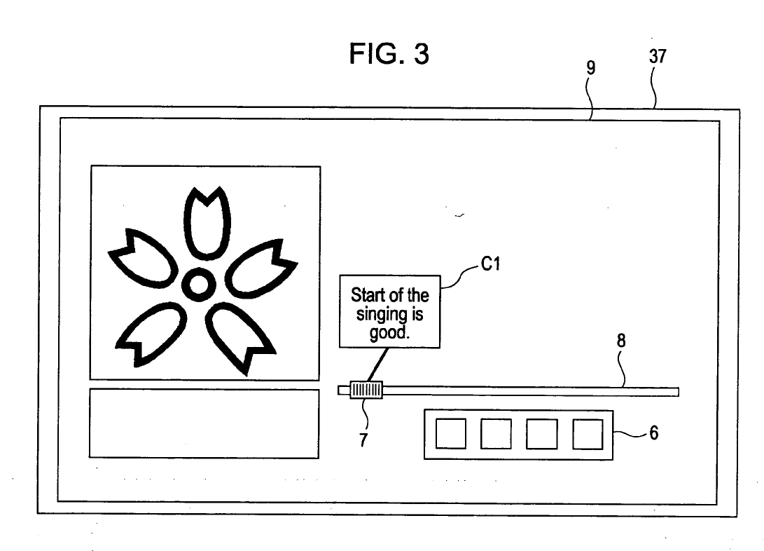

(2-2. Display of Comment in Synchronization with Reproducing of Song: FIGS. 3 to 5)

In an embodiment of the present invention, during reproducing of a song, the above-described time-series meta information of the song is obtained and referred to, so that comments indicated by respective pieces of comment information are displayed on the display in synchronization with reproducing of the song.

As a method for obtaining song data and time-series meta information of a song to be reproduced in the music reproducing apparatus 10 shown in FIG. 1, any of the following methods (a) to (d) can be used.

(a) The song data and the time-series meta information are received and obtained from the distribution server 200 at reproducing.

(b) The song data and the time-series meta information are recorded on a CD or a hard disk as the storage unit 21 and are read from the storage unit 21 at reproducing.

(c) The song data is recorded on the storage unit 21 and is read therefrom at reproducing, while the time-series meta information is received and obtained from the distribution server 200 at reproducing.

(d) The time-series meta information is recorded on the storage unit 21 and is read therefrom at reproducing, while the song data is received and obtained from the distribution server 200 at reproducing.

In method (a), when the song data is to be received for test listening of the entire song from the distribution server 200 so as to reproduce the song by streaming, the time-series meta information can be received from the distribution server 200 and comments can be displayed.

Method (b) can be used if a user has obtained the song data and the time-series meta information. Method (c) can be used if the user has obtained only the song data. Method (d) can be used if the user has obtained only the time-series meta information.

In any of the above-described methods, the CPU 11 of the music reproducing apparatus 10 obtains the time-series meta information of the song from the distribution server 200 or the storage unit 21 and holds it on the RAM 15 prior to start of reproducing the song.

Also, the CPU 11 displays a reproducing status display screen 9 on the display 37 and indicates a reproduced position of the song by a reproduced position marker 7 on a reproduced position display bar 8 during reproducing, as shown in FIG. 3. Of course, the status is different from that shown in FIG. 3 at start of reproducing, that is, the reproduced position marker 7 is positioned at the left edge.

Alternatively, a group of buttons 6 for stopping reproducing, switching from stop to reproducing, fast-forward, and fast-rewind, and an image related to the song may be displayed on the reproducing status display screen 9.

When the reproduced song is the above-described song Sa and when the time-series meta information thereof is the information shown in FIG. 2, reproducing of the song and display of comments are performed in the following manner. In a state where the time-series meta information is held on the RAM 15 and where the reproducing status display screen 9 is displayed on the display 37, the CPU 11 starts reproducing song Sa and starts moving the reproduced position marker 7 while referring to the time-series meta information held on the RAM 15.

After the start of reproducing, when the marker 7 reaches the start position of part P1 indicated by the partial reproduced position information in the first partial meta information M1, the CPU 11 displays comment C1 “start of the song is good” while associating it with the reproduced position marker 7 in the reproducing status display screen 9 by the comment information about part P1, as shown in FIG. 3. Comment C1 is kept displayed until the end of part P1.

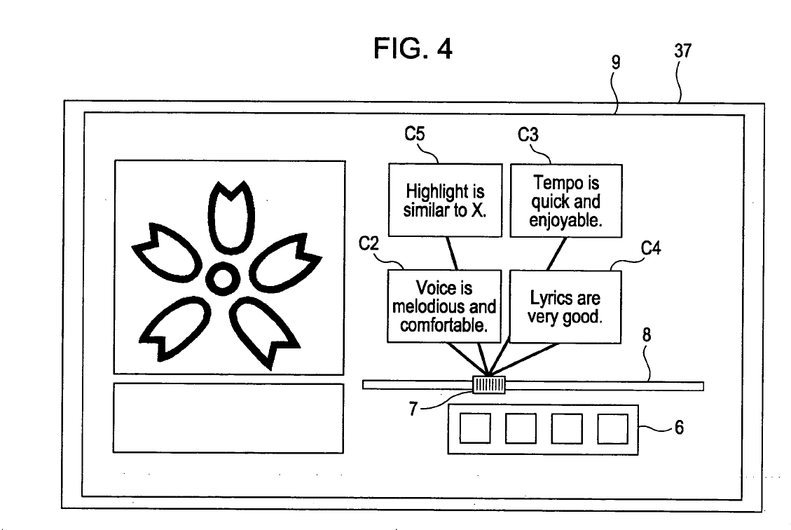

Then, when the marker 7 reaches the start positions of parts P2, P3, P4, and P5 indicated by the partial reproduced position information in the respective pieces of partial meta information M2, M3, M4, and M5, the CPU 11 displays comments C2, C3, C4, and C5 while associating them with the reproduced position marker 7 in the reproducing status display screen 9 by the comment information about parts P2, P3, P4, and P5, as shown in FIG. 4. Comments C2, C3, C4, and C5 are also kept displayed until the end of parts P2, P3, P4, and P5.

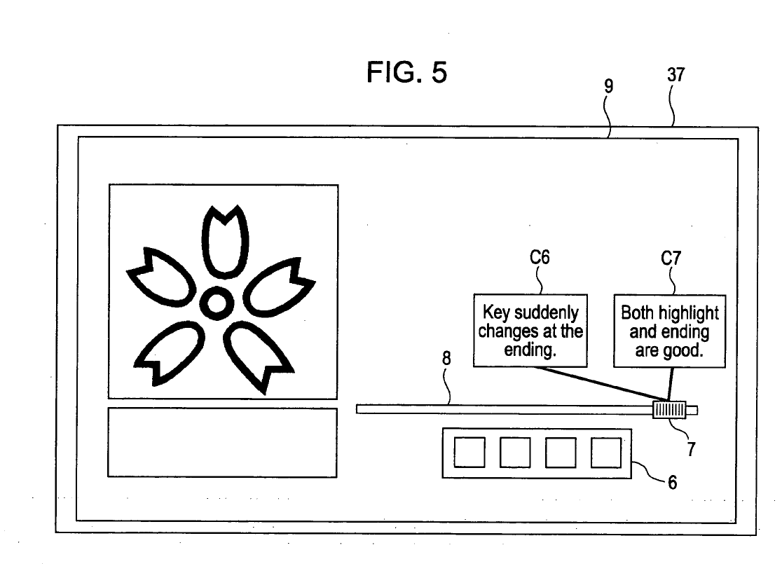

Then, when the marker 7 reaches the start positions of parts P6 and P7 indicated by the partial reproduced position information in the respective pieces of partial meta information M6 and M7, the CPU 11 displays comments C6 and C7 while associating them with the reproduced position marker 7 in the reproducing status display screen 9 by the comment information about parts P6 and P7, as shown in FIG. 5. Comments C6 and C7 are also kept displayed until the end of parts P6 and P7.

In the above-described method, the user can read comments about respective parts of a song while listening to the song. Accordingly, the user can aurally and visually realize the feature of the song, the similarity and difference between the song and another, and so on, over details of the song.

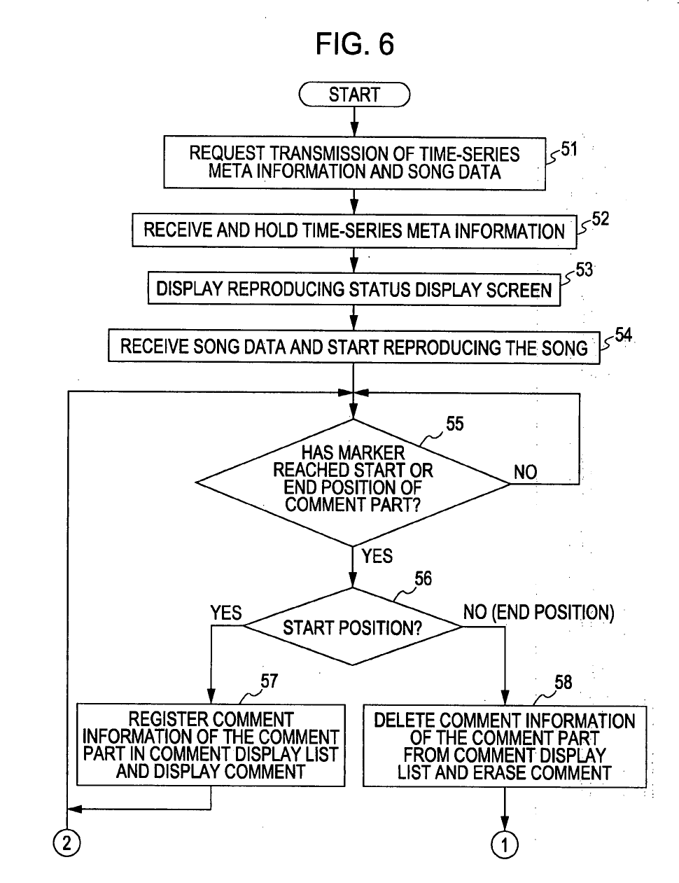

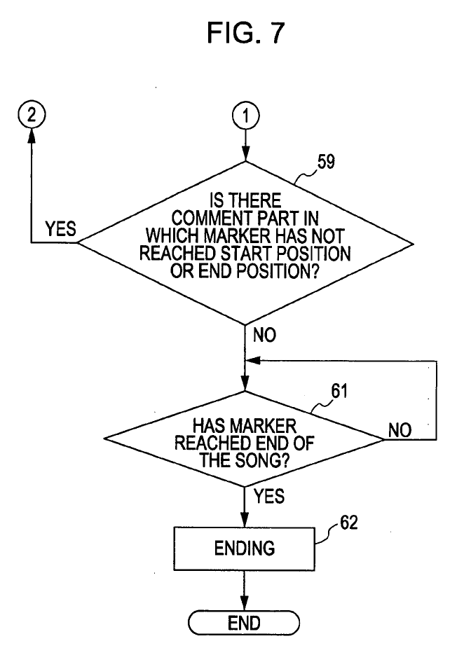

(2-3. Process of Reproducing Song and Displaying Comment: FIGS. 6 and 7)

FIGS. 6 and 7 show an example of a process of reproducing a song and displaying a comment performed by the CPU 11 of the music reproducing apparatus 10.

This example is applied in the above-described method (a), that is, in a case where song data and time-series meta information are received and obtained from the distribution server 200 so as to reproduce the song by streaming as in test listening of the entire song.

In this example, the CPU 11 starts the entire process in response to instructions from a user in a state where the music reproducing apparatus 10 is connected to the distribution server 200 via the Internet 100. In step 51, the CPU 11 requests transmission of the time-series meta information and song data of the song to the distribution server 200.

In response to the request, the distribution server 200 transmits the time-series meta information of the song to the music reproducing apparatus 10. In step 52, the CPU 11 of the music reproducing apparatus 10 receives the time-series meta information and holds it on the RAM 15. In step 53, the CPU 11 displays the above-described reproducing status display screen 9 on the display 37.

Then, the distribution server 200 transmits the song data of the song to the music reproducing apparatus 10. In step 54, the CPU 11 of the music reproducing apparatus 10 receives the song data, starts reproducing the song, and also starts moving the reproduced position marker 7 on the reproducing status display screen 9.

Then, while continuing reproducing of the song, the CPU 11 of the music reproducing apparatus 10 determines whether the marker 7 has reached the start position or end position of a comment part in step 55. If determining that the marker 7 has reached the start position or end position, the process proceeds to step 56, where the CPU 11 determines whether the position is the start position or the end position.

If determining in step 56 that the marker 7 has reached the start position of a comment part, the process proceeds to step 57, where the CPU 11 registers comment information of the comment part in a comment display list on the RAM 15 and displays the comment corresponding to the comment part. Then, the process returns to step 55.

On the other hand, if determining in step 56 that the marker 7 has reached the end position of a comment part, the process proceeds to step 58, where the CPU 11 deletes comment information of the comment part from the comment display list on the RAM 15 and erases the comment corresponding to the comment part. Then, the process proceeds to step 59.

In step 59, the CPU 11 determines whether there exists a comment part in which the marker 7 has not reached the start position or end position. If exists, the process returns to step 55. Otherwise, the process proceeds to step 61.

In step 61, the CPU 11 determines whether the marker 7 has reached the end of the song. If determining that the marker 7 has reached the end of the song, the process proceeds to step 62, where an ending process is performed and then the process of reproducing the song and displaying the comments completes.

In the ending process performed in step 62, the CPU 11 erases the reproducing status display screen 9 and also erases the time-series meta information of the song from the RAM 15 as necessary.

When the reproduced song is the above-described song Sa and when the time-series meta information thereof is that shown in FIG. 2, the process is performed in the following way. After reproducing starts in step 54, comment C1 corresponding to part P1 is displayed in step 57 after steps 55 and 56. Then, comment C1 corresponding to part P1 is erased in step 58 after steps 55 and 56.

Then, comment C2 corresponding to part P2 is displayed in step 57 after steps 59, 55, and 56. Likewise, comment C3, C4, and C5 corresponding to parts P3, P4, and P5 are sequentially displayed in step 57 after steps 55 and 56.

Then, comment C2 corresponding to part P2 is erased in step 58 after steps 55 and 56. Likewise, comments C3, C4, and C5 corresponding to parts P3, P4, and P5 are sequentially erased in step 58 after steps 59, 55, and 56.

Then, comment C6 corresponding to part P6 is displayed in step 57 after steps 59, 55, and 56. Also, comment C7 corresponding to part P7 is displayed in step 57 after steps 55 and 56.

Then, comment C7 corresponding to part P7 is erased in step 58 after steps 55 and 56. Then, comment C6 corresponding to part P6 is erased in step 58 after steps 59, 55, and 56. Then, the process proceeds from step 59 to steps 61 and 62. Accordingly, the entire process ends.

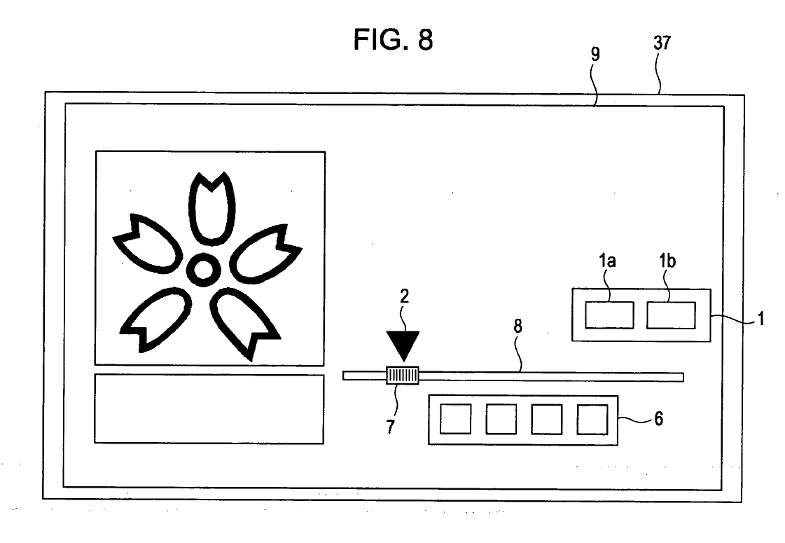

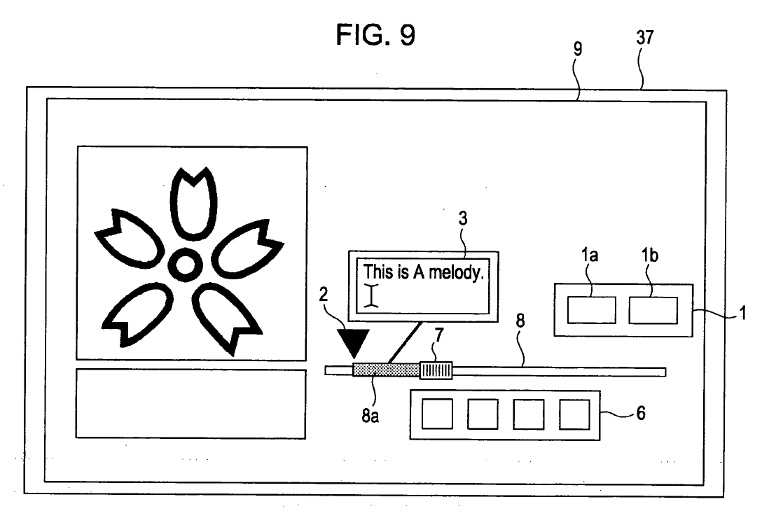

(2-4. User Partial Meta Information: FIGS. 8 and 9)

In the music reproducing apparatus 10 shown in FIG. 1, comments about respective parts of a song can be displayed in synchronization with reproducing of the song, as described above. Furthermore, if a user specifies a part of the song during the reproducing and inputs a comment about the specified part, user partial meta information can be generated. The user partial meta information includes partial reproduced position information indicating the reproduced position of the part in the song and comment information indicating the comment about the part.

Specifically, as shown in FIG. 8, for example, a part specifying button 1 including a start position specifying button 1a and an end position specifying button 1b is displayed on the reproducing status display screen 9 during reproducing of the song.

If the user wants to input his/her evaluation or comment about a part of the song, the user presses the start position specifying button 1a at the start of the part and presses the end position specifying button 1b at the end of the part.

Upon press on the start position specifying button 1a, an input marker 2 is displayed at the position of the reproduced position marker 7 at that time, as shown in FIG. 8. Upon press on the end position specifying button 1b, a bar portion 8a corresponding to the part of the song from the start position indicated by the press on the start position specifying button 1a to the end position indicated by the press on the end position specifying button 1b in the reproduced position display bar 8 is highlighted with a different color or the like, and a comment input section 3 is displayed, as shown in FIG. 9. Accordingly, the user can input a comment.

After the user has input a comment in the comment input section 3, the CPU 11 of the music reproducing apparatus 10 generates user partial meta information having the same configuration as that of each piece of the partial meta information M1 to M7 shown in FIG. 2. The user partial meta information includes partial reproduced position information indicating the reproduced position of the part specified by the user in the song and comment information indicating the comment about the part.

If the user repeats the above-described specification and input, a plurality of pieces of user partial meta information can be generated for the same song.

As a method for using the user partial meta information, the following first or second method can be used.

In the first method, the user partial meta information generated in the above-described manner in the music reproducing apparatus 10 is transmitted to the distribution server 200.

In the distribution server 200, if the user partial meta information is appropriate, the user partial meta information is added as partial meta information to the time-series meta information of the song, or an existing piece of partial meta information in the time-series meta information is replaced by the user partial meta information.

Accordingly, opinions of users (evaluations and comments of users about respective parts of the song) can be reflected on the time-series meta information transmitted from the distribution server 200 to the users, so that a community can be established via music.

In this case, the date and time of transmission or reception may be added to the user partial meta information so that the time-series meta information of the song is updated periodically (e.g., weekly or monthly) in the distribution server 200.

In the second method, in a case where the time-series meta information is recorded on the storage unit 21 as in the above-described method (b) or (d), generated user partial meta information is added as partial meta information to the time-series meta information of the song, or an existing piece of partial meta information in the time-series meta information is replaced by the user partial meta information in the music reproducing apparatus 10.

Accordingly, the user can change some or all pieces of the partial meta information in the time-series meta information as he/she likes.

It should be understood by those skilled in the art that various modifications, combinations, sub-combinations and alterations may occur depending on design requirements and other factors insofar as they are within the scope of the appended claims or the equivalents thereof.

What is claimed is:

1. A music reproducing method in a music reproducing apparatus, the method comprising the steps of:
obtaining time-series meta information including a plurality of pieces of partial meta information corresponding to a plurality of parts of song data, each piece of the partial meta information including partial reproduced position information indicating a reproduced position in the song data and comment information indicating a comment about the song at the reproduced position; and
displaying the comment indicated by each piece of the comment information on a display by referring to the time-series meta information during reproducing of the song data.

2. The music reproducing method according to claim 1,
wherein, if the reproduced positions defined by some pieces of the partial meta information of the time-series meta information overlap each other at least partially, respective comments are simultaneously displayed.

3. The music reproducing method according to claim 1,
wherein the song data and the time-series meta information of the song are obtained from a distribution server connected via a network.

4. The music reproducing method according to claim 1,
wherein the song data and the time-series meta information of the song are recorded on a storage unit that is included in the music reproducing apparatus or that is attached to or connected to the music reproducing apparatus.

5. The music reproducing method according to claim 1,
wherein one of the song data and the time-series meta information of the song is recorded on a storage unit that is included in the music reproducing apparatus or that is attached to or connected to the music reproducing apparatus, and the other is obtained from a distribution server connected via a network.

6. The music reproducing method according to claim 1, further comprising:
generating, during reproducing of a song, user partial meta information in accordance with an operation of inputting a comment about the song at a reproduced position performed by specifying the reproduced position of the song, the user partial meta information including partial reproduced position information indicating the reproduced position in the song and comment information indicating the comment about the song at the reproduced position.

7. The music reproducing method according to claim 6,
wherein the user partial meta information is transmitted to a server serving as an information collector by accessing the server via a network.

8. A music reproducing apparatus comprising:
reproducing means for reproducing song data;
obtaining means for obtaining time-series meta information including a plurality of pieces of partial meta information corresponding to a plurality of parts of the song data, each piece of the partial meta information including partial reproduced position information indicating a reproduced position in the song data and comment information indicating a comment about the song at the reproduced position; and
control means for displaying the comment indicated by each piece of the comment information on a display by referring to the time-series meta information during reproducing of the song data.

9. The music reproducing apparatus according to claim 8,
wherein, if the reproduced positions defined by some pieces of the partial meta information of the time-series meta information overlap each other at least partially, the control means simultaneously displays respective comments.

10. The music reproducing apparatus according to claim 8, further comprising:
means for accessing a distribution server via a network and obtaining the song data or the time-series meta information of the song from the server.

11. The music reproducing apparatus according to claim 8, further comprising:
input means for inputting a comment about a song at a reproduced position by associating the comment with the reproduced position of the song during reproducing of the song by the reproducing means,
wherein, if the comment is input by the input means, the control means generates user partial meta information including partial reproduced position information indicating the reproduced position in the song and comment information indicating the comment about the song at the reproduced position.

12. The music reproducing apparatus according to claim 11, further comprising:
means for accessing a server serving as an information collector via a network and transmitting the user partial meta information to the server.

13. A recording medium storing a program allowing a computer to function as:
means for obtaining time-series meta information including a plurality of pieces of partial meta information corresponding to a plurality of parts of song data, each piece of the partial meta information including partial reproduced position information indicating a reproduced position in the song data and comment information indicating a comment about the song at the reproduced position; and
means for displaying the comment indicated by each piece of the comment information on a display by referring to the time-series meta information during reproducing of the song data,
so as to present comments about a plurality of parts of the song data.

14. A music reproducing apparatus comprising:
a reproducing unit configured to reproduce song data;
an obtaining unit configured to obtain time-series meta information including a plurality of pieces of partial meta information corresponding to a plurality of parts of the song data, each piece of the partial meta information including partial reproduced position information indicating a reproduced position in the song data and comment information indicating a comment about the song at the reproduced position; and
a control unit configured to display the comment indicated by each piece of the comment information on a display by referring to the time-series meta information during reproducing of the song data.
